(19) United States
(12) Patent Application Publication
(10) Pub. No.: US 2002/0095349 A1
(43) Pub. Date: Jul. 18, 2002

(54) Net market system

(76) Inventor: Isao Sugiyai, San Bruno, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/866,228

(22) Filed: May 25, 2001

(30) Foreign Application Priority Data
May 26, 2000 (JP) 2000-156841

(51) Int. Cl. G06F 17/60

(52) U.S. Cl. 705/26

(57) ABSTRACT

A net market system, the net market system functioning as a portal for buying/selling and exchanging goods, information, and services via a network, that comprises net market system connection/management means that performs transmission and receptions of messages with the users via communication appliances, transactions monitoring means that monitors transactions within the net market system, data storing/providing means that stores data necessary for the execution of processing based on the messages from the users or that provides that data according to the requests made by the users' messages, application software providing means that provides application software that is necessary for the execution of processing based on the requests made by the users' messages, legacy-system interface providing means that provides an interface for having access to, or utilizing, legacy systems or software, and process-execution integrating/controlling means that integrates and controls the execution of processing within the net market system.

### BACKGROUND OF THE INVENTION

1. Field of the Invention

The present invention relates to a net market system that provides an infrastructure for buying/selling or exchanging various goods, information, or services via a network.

2. Description of the Related Art

With an increase in the degree of diffusion of the Internet or Intranet, exchanging information, buying/selling goods, and providing services via a network have been rapidly expanded. When trying to conduct the buying/selling and exchange of goods, information, and services via the network, an user can connect to a particular Web site that provides such services and enjoy the provision of them. For example, when having tried to obtain information about a particular item via the network, if trying to gather information items over a range as wide as possible, the user tries to access a plurality of different databases or search engine of the Internet and, by making his choice from the searched results, to obtain the most appropriate combined form of information items. Also, when trying to get a particular item of goods via the network, it is preferable that the user can collect information as widely as possible from related buying/selling markets and, by comparing and examining all relevant buying conditions, can get that item of goods under the most appropriate buying conditions. If there is provided no means for comparing by having a look at the buying conditions in the respective relevant buying/selling markets, the user needs to compare by accessing every relevant market. In this way, when trying to obtain information or the like by accessing each of a plurality of databases or markets, if there is a means that enables obtaining appropriate information more efficiently, it is possible to draw a larger number of users' attention toward the transaction markets. As a result, it can be expected that collecting and exchanging information and transactions of goods via the network will be more expanded and furthered.

On the other hand, recently, the number of enterprisers who try to open and run various enterprises or businesses through the use of networks has been increasing. For those enterprisers, constructing a system for running their net businesses that is based on the use of hardware and software, managing and maintaining that system, money-charging process with respect to users, etc. all at their own expense become a great burden upon them. Therefore, it is desirable that, regarding general-purpose businesses, outsourcing be done as much as possible, whereby enterprisers' resources can be utilized, as concentratedly as possible, for preparation of services (or goods or information) they intend to offer to the users. Here, in a case where such outsourcing is done by the enterprisers, it is important that a system via that outsourcing is easy to use, has excellent cost performance, and has high reliability for both of the enterprisers and the users. For the enterprisers, that they can select such system results also in the procurement of a large number of users. Especially, in a case where operating an enterprise via a network, that the accessibility is high in speed; the system-down due to the accesses on a large scale is less; the system has high conformability and flexibility with respect to the changes or enhancement of its architecture, and so on becomes an important factor when judging the reliability of the system via that outsourcing is to be done.

In addition, recently, means for allowing the users to connect to a relevant network has included using mobile phones and personal digital assistants as well as using computers and has thus gone on being diversified. Therefore, it is being demanded that the users can smoothly connect to the network from any appliance or device with no unnatural feeling and thereby enjoy having services offered to them.

### SUMMARY OF THE INVENTION

An object of the present invention is to provide a new business model called “a net market system” which, regarding transactions performed via a network, for the users, makes the market easy to use and makes the use of it flexible and, for the enterprisers, has high reliability and the excellent capability of being enhanced and enables a high quality of services to be offered to the users, and which is usable as an infrastructure and in which the applications, data, and communications are integrated together.

A net market system according to the present invention is the one functioning as a portal for buying/selling and exchanging goods, information, and services via a network, that comprises net market system connection/management means that functions as an interface for communications that are made with users via communication appliances including mobile phones, facsimiles, personal computers, and personal digital assistants, transactions monitoring means that monitors transactions within the net market system that follow the execution of processing based on the messages sent from the users, data storing/providing means that has been connected to the Internet and that stores data necessary for the execution of processing based on the messages from the users or that provides that data according to the requests made by the users' messages, application software providing means that provides application software that is necessary for the execution of processing based on the requests made by the users' messages, legacy-system interface providing means that provides an interface for having access to, or utilizing, legacy systems or software, and process-execution integrating/controlling means that integrates and controls the execution of processing within the net market system based on the messages from the users. By constructing like that, in the present net market system, applications, data, communications, and controls can be integrated using a method of market centers.

Also, in this net market system, the execution of the processing based on the messages sent from the users is done via agents, or the respective processes of the net market system connection/management means, transaction monitoring means, data storing/providing means, application software providing means, legacy system interface providing means, and process-execution integrating/controlling means that are included in this system are executed by co-operation of the agents and the application software necessary for executing the respective processes or the information processing system. As a result of this, it is possible to provide the system that has high flexibility and expandability. Also, the maintainability in units of a center is high, the property of its being co-operative and reliable as the system in its entirety is excellent, and the integration between the market centers and the addition and deletion of various single-purpose markets can be freely performed.

The net market system connection/management means, transaction monitoring means, data storing/providing means, application software providing means, legacy-system interface providing means, and process-execution integrating/controlling means included in the net market system are executed through the co-operation of the four Web servers: an agent server that executes the management/integration of agents including the creation, dispatch, extinction, and re-use of the agents; a for-traffic-control high-speed cache server that is connected to the Internet and that executes the controls of that includes the controls of cache function, data storage, and URL transfer destination of data that is used and transferred within the net market system; a data server that functions as a database that stores therein and provides data that is used for the execution of processing that are executed within the net market system; and an application software server that provides application software that is used for the execution of processing within the net market system.

The transaction monitoring means can execute a money-charging piece of processing regarding the use of the net market system that is executed with respect to the user. Further, the application software server can provide, with respect to the user, in the way of allowing the user to use the function of application software via the network, the application software that has been accumulated on the server.

The agent server comprises an agent messaging server that has a function of helping the message communications between the agents that are executed between the agents and other agents within the net market system and between the agents and other agents within other net market, an agent name server that manages the definitions and states of the agents that are used within the net market system, an agent monitoring server that records therein the transactions between the agents and thereby manages basic data for being used to offer fundamental services including money-charging information and security management, an agent knowledge server that manages the agent knowledge that the respective agents can use, and an agent event server that manages and operates the events that occur between the agents and the system the agents have relevancy to.

The net market system according to the present invention is excellent compared to the conventional art in the following respects.

(1) The system functions as a portal for the net market that can be applied to the buying/selling and exchange of every item of goods, information and services and permits the integration of application software, data, communications, and controls to be made with the method of utilizing market centers.

(2) By using the intelligent agents for the purpose of performing every message exchange, transaction, etc. within the net market system, the system can provide optimum mixture of information, service, and transaction through agent-to-agent negotiations and auctions.

(3) Since the respective centers of the present net market system are connected to each other by agent-to-agent communications or wrapping, the system can have high flexibility and expandability; the maintainability thereof in units of a center is high; and the property of its being co-operative and reliable as the system in its entirety is excellent. Further, the integration of the market centers between them and the addition and deletion of any given one or ones of various single-purpose markets can be freely performed.

(4) High-speed access with small downtime is guaranteed by managing and controlling the traffic quantity through the use of the high-performance Web cache system.

(5) Dynamic integration of the application software becomes able to be realized by managing the events and messages inside and outside the net market system.

Accordingly, the net market system according to the present invention can be applied to various fields that include the integration into a large-scale information system such as the integration of information systems by a merger of big banks into a larger scale information system, the conversion of a between-bank settlement system into a net market, buying/selling market of power (utility) such as buying/selling of electric power by using multi-auction agents, different-type-of-business integration buying/selling market such as a multiple-business-type market that is destined for general trading companies, a parts preparation market such as a parts preparation market that is destined for automobile companies, a net stock market such as the management and operation of an outside-exchange stock exchange system ECN, a net-based manufacturing-industry integration such as a manufacture, designing, sales, and management integration system the use of that is destined for automobile companies, and outsourcing of IP (Internet protocol) services that are destined for tele-communication companies.

### BRIEF DESCRIPTION OF THE DRAWINGS

FIG. 1 is a block diagram illustrating an embodiment of a net market system according to the present invention wherein relevant portions are shown as blocks mainly according to the aspect of their functions;

FIG. 2 is a block diagram illustrating the embodiment of the net market system according to the present invention at the center, server, and hardware levels;

FIG. 3 is a view typically illustrating an example wherein the net market system according to the present invention is utilized;

FIG. 4 is a view typically illustrating another example wherein the net market system according to the present invention is utilized;

FIG. 5 is a view typically illustrating still another example wherein the net market system according to the present invention is utilized; and

FIG. 6 is a view illustrating the construction of agent servers constructing the net market system according to the present invention.

### DESCRIPTION OF THE PREFERRED EMBODIMENTS

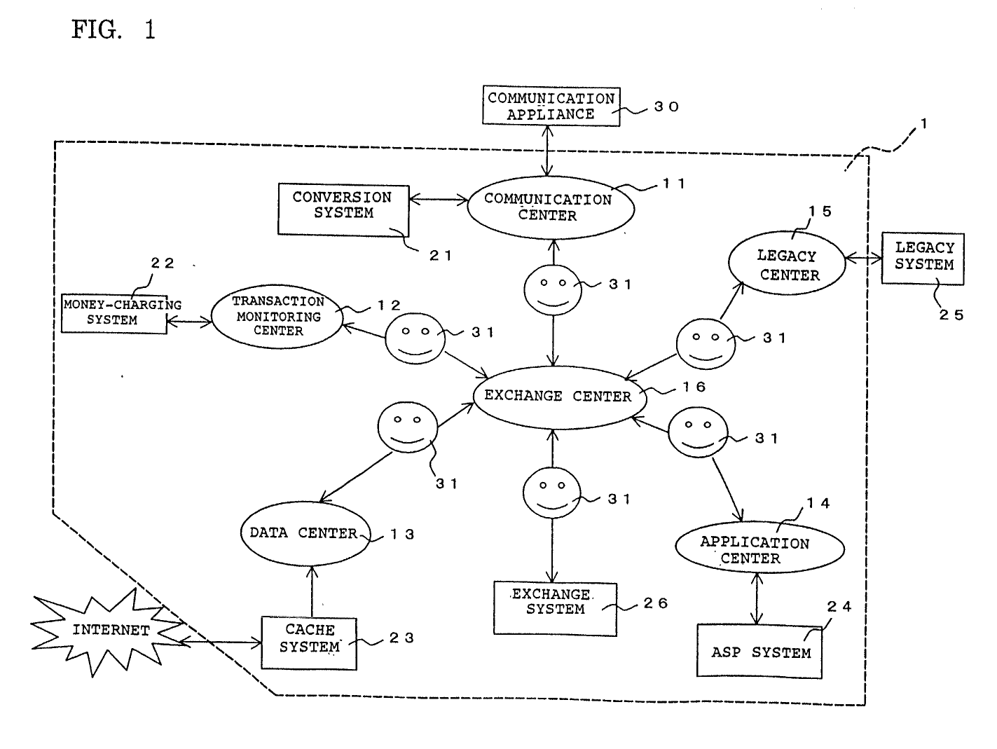

FIG. 1 is a block diagram illustrating an embodiment of a net market system according to the present invention wherein relevant portions are shown as blocks mainly according to the aspect of their functions. In FIG. 1, each of respective centers that are indicated by elliptic blocks 11 to 16 co-operates with other centers and has a peculiar function of constructing a net market system while co-operating with them. On the other hand, each of respective systems 21 to 26 that are indicated by rectangular blocks and each of respective agents 31 that are indicated by blocks like human faces are respectively pieces of software for executing the function of each of the respective centers 11 to 16. Each of the respective systems 21 to 26 is an application software, software system, or information processing system for executing the function that is peculiar to a relevant one of the respective centers. With these respective systems 21 to 26 and agents 31, the functions of the respective centers are executed. Namely, the respective centers that are so referred to here are not nodes on the network but can be said to be what is called function execution means for the net market system 1 that has been virtually constructed by software.

Here, the agent is a constituent element (module) that is used for constructing the software system. General features of the agent include the following. The property of being autonomous and active that the agent can make its judgement or solve the problems by making use of its own knowledge or various items of information, the property of being co-operative that by having introduced therein languages or protocols enabling fellows of the agents to make their communications a plurality of agents can solve the problems while co-operating with one another, and the property of being flexibly conformable to external factors or changes in the environment.

The agent 31 that is applied to the net market system 1 according to the present invention has a function of moving on the network. The agent 31, while moving on the network, executes prescribed processing and mediation of prescribed processing according to the messages sent from the users. Also, a plurality of autonomous agents 31 perform problem distribution and solution for executing prescribed processing through the use of procedures such as negotiations, bids, auctions, etc. The feature of the present net market system 1 is that the exchange of messages between the centers, the processing of messages, etc. are executed by being mediated by the agents 31. Each of these agents 31 can have knowledge that is necessary for its relevant processing. Namely, the present net market system 1 is controlled and integrated by the communications between the agents 31.

Next, the construction and function of the net market system 1 according to this embodiment will be explained. The net market system 1 according to this embodiment is the one for being applied to the buying/selling and exchanging goods and information, with wireless communications and broadband connections being premised, that includes the following. A communication center 11 that accepts the messages sent from the users that have been transmitted from various communication apparatuses 30 that includes mobile phones, facsimiles, personal computers, and personal digital assistants. A transaction monitoring center 12 that monitors all transactions within the net market system 1 to thereby execute money-charging, etc. A data center 13 that collects, accumulates, and provides data that is used in each of the respective centers in the net market system 1. An application center 14 that performs hosting of various applications in the form of an ASP (Application Service Provider). A legacy center 15 that makes its connections with legacy systems (the existing systems) to thereby provide necessary information. An exchange center 16 that has a function of performing reception/transmission and exchange of the messages between the centers, format conversion, and integration of the net market system 1 as a whole. Next, a detailed explanation will be given of the respective centers.

The communication center 11 functions as an interface that is used when the user who is utilizing the net market system 1 connects to the net market system 1 by the use of the communication apparatus 30 such as a portable telephone, a facsimile, a personal computer, a mobile information terminal, etc. Specifically, the communication center 11 executes account setup processing for an initial user, log-in processing for connections, or authentication procedures for connections. Also, the communication center 11 stores therein communication records with the communication apparatus 30, for example, as a HTML format. For storing those communication records, a cache system 23 as later described is used. Further, the communication center 11 performs data format conversion that needs to be performed when receiving a connection from each of a plurality of users' different communication apparatuses and then delivering toward each of the respective centers the messages that are used for executing various processing in the net market system 1 and, on the other hand, providing data that has been processed or information that has been gathered via the net market system 1 toward each of the users' respective communication apparatuses. In addition, the communication center 11 performs operations such as extracting necessary information for providing to the users the gathered information (contents) correspondingly to the formats of various communication apparatuses that are users' communication means. The format conversion, in case of a portable telephone, is the mutual conversion between the HTML and a c(Compact)-HTML or the mutual conversion between the HTML and a WML made in accordance with WAP (Wireless Application Protocol) or the like. For those protocol conversion or format conversion in the communication center 11, a conversion system 21 is used. For example, a software Prism 3.0 (trademark) that was developed by Spyglass Company can be used.

The transaction monitoring center 12 receives the results of all transactions performed within the net market system 1 from other centers within the net market system 1. By monitoring the transactions within the net market system 1 in that way, the transaction monitoring center 12 executes money-charging process, bill issuance process, etc. with respect to the users. It is to be noted that data that is necessary for the money-charging process such as clients' information and money-charging data is accumulated in the data center 13 as later described while, on the other hand, the transaction monitoring center 12 executes money-charging process, etc. according to those data that have been accumulated in the data center 13. A money-charging system 22 is an application program for executing the money-charging, etc. For example, the software “Infranet” (trademark) that was developed by Portal Company can be used as such application program.

The data center 13 is connected to the Internet via the cache system 23. The data center 13 accumulates information that has been gathered from the Internet and respective centers and provides it to the other centers. Here, the wording “cache” means temporarily storing Web contents and the like in order to execute data transfer between the Internet and the respective centers and data processing at a high speed. For example, when the user accesses a page of WWW, the data center 13 stores therein that content for a prescribed period of time. Then, when another user has accessed the same page next, there is no need to access the Internet and, instead, the data center 13 return-transmits the information that it has to the user. By doing so, it is possible to reduce the frequency with which to access the Internet.

Also, the basic data necessary for the other centers, e.g. the clients' information and money-charging information that are utilized by the transaction monitoring center 12, or the necessary data for the execution of the application software that is provided from the application center 14, also, is provided from the data center 13. At that time, the data center 13 performs format conversion that needs to be done when data is stored or read out. Further, the data center 13 according to the necessity functions also as a search engine for gathering information from the Internet. The cache system 23 that realizes the cache function of the data center 13 is constructed of a high-speed cache server (e.g. a server made by Inktomi Company) and a control application therefor. It thereby controls the cache function, data storage, and URL transfer destination and updates the Web contents that are cached. It also has a high-speed search engine. By making use of such cache system 23, it becomes possible to decrease the system down that occurs due to the high-speed accesses and the large-scale of accesses.

The application center 14 performs hosting of application software, such as an ERP (Enterprise Resource Planning, an integrated software of basic business affairs having packaged therein basic business affairs such as accounting, production control, sales management, personnel management, etc.) or wireless data entry application, in the form of an ASP (Application Service Provider, an enterpriser who provides application functions for business via a network). The function of the application center 14 is realized by an ASP system 24. The application center 14 functions as an aggregate of all applications inside and outside the system. It performs ASP services including that for the present system itself. In addition, other than this, regarding the part unable to be coped with by those ASP services, it asks the legacy center 15 and, by making concurrent use of legacy systems, copes with the users' requests. Also, as seen in its operation of converting the requests made from wireless appliances such as mobile phones into an input to an ERP, it functions as an interface for receiving a request to utilize the ASP via the exchange center 16 as later described.

The legacy center 15 functions as a gateway to all legacy systems. Namely, it is connected to a legacy system 25 and thereby gets necessary information. For that reason, it performs data format, data structure conversion or input/output conversion for utilizing existing database systems, existing software packages, or the like. For utilizing the legacy system 25 in the present market system in that way, the technique that is called “Wrapping” is used. The wording “Wrapping” means adding an interface (e.g. a language conversion function or a communication language) for making the legacy system available in the present net market system, to outside the legacy system, without modifying the legacy software itself.

The exchange center 16 mediates the reception and transmission of the messages between the centers and plays the role of integrating the net market system 1 as a whole, such as data conversion on format or protocol, control of access to the Internet, or control of caching for the data center 13. The exchange system 26 is constructed of a group of applications for performing exchange of various data, control of user's accesses by determining whether the requests made by the users are private or on business, notification of changes, request for updating, etc.

Here, in the net market system 1 according to this embodiment, a number of agents 31 are staying at all times. The net market system 1 provides the place where respective agents of such agent group exchange their messages between them, or the place where, for executing various processes, the agents 31 negotiate between them or distribute problems according to the protocol simulating bids, auctions, etc. It is to be noted that the negotiations, auctions, successful bids, etc. that are performed by those agents 31 will be later explained in more detail while actual examples are being taken up.

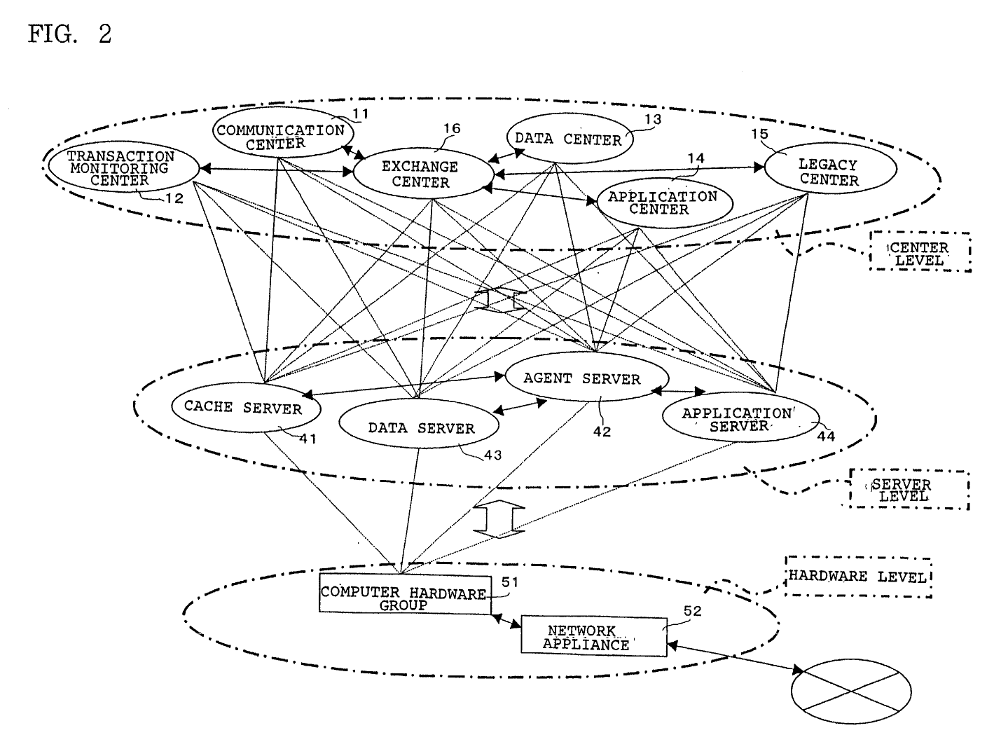

Next, using FIG. 2, the construction for realizing the present net market system will be explained. FIG. 2 illustrates the net market system in units of centers, servers, and hardware. The fine dotted-lines in FIG. 2 represent the relationship of the constituent portions at each level and those at another level. The construction at the server level of the present net market system 1 includes the following four Web servers. Namely, an agent server 42 that performs the management/control of the agents 31 such as creation, dispatch, extinction, and re-use of the agents that control the net market system as a whole. A cache server 41 that performs control of the cache function, data storage, URL transfer destination, etc. in the entire system and that has the ability of performing the processes at a very high speed. A data server 43 that has the function that works as the database that provides the basic data in the respective processes executed within the system, the data (client's information, money-charging information, etc.) that are frequently utilized, etc. An application server 44 that provides, in the way an application service provider does, various application software that are executed within the system.

These servers 41 to 44 are nodes that work on the network system. They ordinarily are dispersed into a plurality of computer hardware group 51. Of course, they can be also allotted to a single unit of computer hardware. Considering the reliability of the system, it is more preferable in the sense of decreasing the downtime and enhancing the reliability that such nodes be constructed using a number of computers that although their individual abilities are somewhat interior to are cheaper and in the way such nodes are dispersed into them, than that such nodes be constructed using a lesser number of computers that each are large in scale and high in performance (and high in cost). It is to be noted that, at the hardware level, the above-described computer hardware group 51 are connected, via network appliances 52, to the Internet or other network systems.

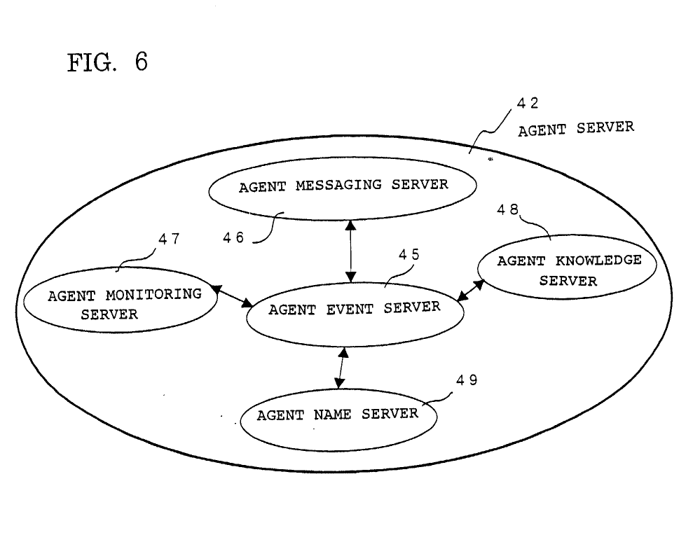

Here, a more detailed explanation will be given of the construction of the agent server 42 with reference to FIG. 6. The agent server 42 is the node on the computer that has the following five servers: an agent event server 45, an agent messaging server 46, an agent monitoring server 47, an agent knowledge server 48, and an agent name server 49. The agent server 42 is a center that functions by those five servers co-operating with one another.

The agent event server 45 has the function of managing and operating the events that are occurring between the agents 31 and the systems they have relevancy to. Namely, the other four servers can each be synchronized with the agent event server 45 through its event-managing function and this enables the collaborations between the agents 31 within the net market system. The agent event server 45 can be constructed, for example, by Meta App server (trademark) manufactured by iSphere Company. The agent event server 45 is the core that manages the synchronization of it with each of the four servers by the Event-Driven method.

The agent messaging server 46 supports the message communications between the agents 31 within the net market and the agents 31 within the other net markets. The agent messaging server 46 has a feature in that it is loosely connected to the agents 31 by supporting exchange of the messages between the agents 31. It delivers messages, provides a write board, provides a function of chat between the agents 31 or between the users, etc. It thereby is utilized for the communications, the transmissions of the request, the return-transmission of the results, etc. between the agents 31, systems, and humans (users). The agent messaging server 46 does not only support the communications between the agents within one net market. But, even between the agents within the one net market and the agents related to the other systems, between those agents and the agents within the other net markets, between those agents and the users related to such systems or within such other net markets, the agent messaging server 46 performs message exchanges beyond the firewalls via the network to thereby enable the synchronization to be established between the agents and the exchange of information between the agents. The agent messaging server 46 can be constructed, for example, by Kizna (tradmark) manufactured by Kizna Company.

The agent monitoring server 47 records the transactions between the agents 31 and thereby manages the basic data for providing the fundamental services such as providing the money-charging information, maintaining the security, etc. The agent monitoring server 47 monitors the activities of the agents 31 by utilizing the function that works as a firewall such as packet filtering or contents checking.

The agent knowledge server 48 has the function of dynamically managing the agent knowledge the respective agents 31 can utilize. Through the operation of the agent knowledge server 48, it is arranged that the agent 31 dynamically can take in the knowledge available or store the knowledge it learned.

The agent name server 49 manages the definition and state of each agent 31 that is used within the net market system. The agent name server 49 is the place where it makes the definition of the agent 31 itself and at the same time keeps stored therein in time series the dynamic state of the agent 31. As a result of this, the past history, together with the recording of the creation, becomes able to be provided for their use and, therefore, the agent name server 49 becomes a server that is necessary for the integration of and between the markets or at the time of error recovery.

The agent knowledge server 48 and the agent name server 49 can each be realized with a relational database or an object database.

As described above, the respective centers 11 to 16 are imaginary function-execution means that is constructed using software and, actually, their functions are executed by having provided thereto the services from the respective servers 41 to 44. Taking up the communication center 11 as an example, the application software for executing the connection processing with respect thereto from the communication appliance (not illustrated) is provided from the application server 44. And those application software, and the agent (not illustrated) equipped with the knowledge for use for the communication center 11, that has been dispatched from the agent server 42, co-operate to execute the connection processing, authentication processing, etc. according to the data that is provided from the data server 43 or to accumulate the results on the data server 43. The data that has been determined as being temporarily stored through the execution of the processes in the communication center 11 is accumulated on the cache server 41. And, according to the necessity, that data is provided from the cache server 41. In the processes of the respective other centers 12 to 16 as well, in the same way, these centers have provided thereto the services from the respective servers 41 to 44, whereby their respective functions are executed.

Next, the operational flows that occur when the user has performed information collection and performed bidding for a public construction work by utilizing the net market system 1 according to this embodiment will be explained with the use of FIGS. 1, 3 and 4.

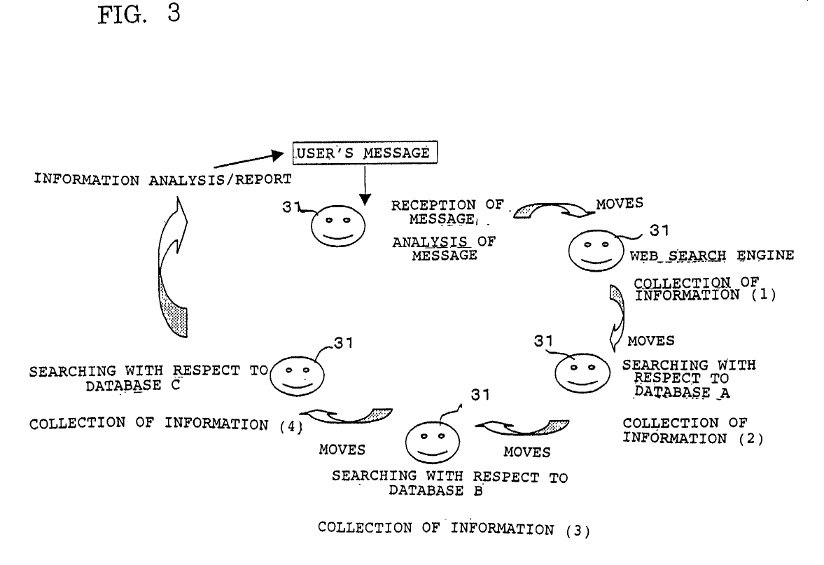

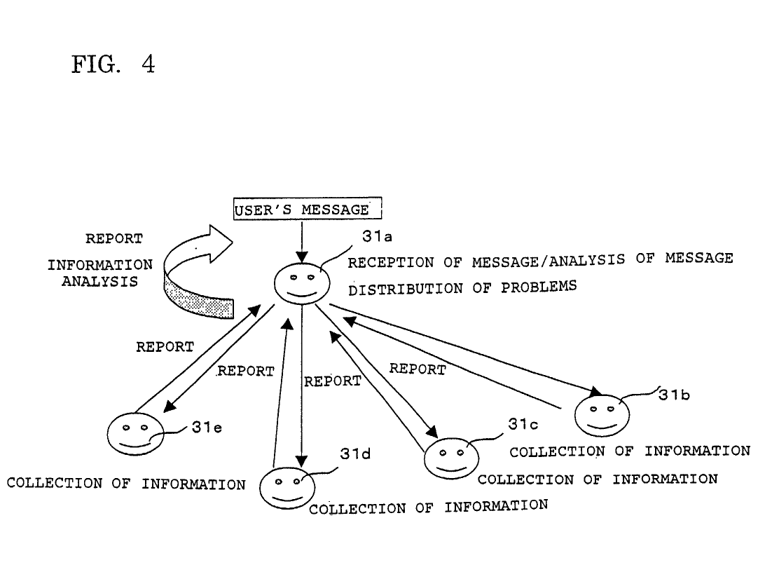

FIGS. 3 and 4 are views typically illustrating a case where the user performs information collection by utilizing the present net market system 1. First, the user, as illustrated in FIG. 1, accesses the communication center 11 by using the communication appliance 30 the user has. The communication center 11 executes log-in process and authentication procedure for performing connection to the user. These transaction data are transmitted to the transaction monitoring center 12. The user who has finished making that connection transmits a message on the information the user wants to collect. It is the agent 31 that receives that message and executes relevant processing. The agent 31 has accumulated thereon the knowledge for determining how to analyze that message and how to execute relevant processing thereto. Therefore, the user does not need to routinely instruct a search item in the user's message, for example, unlike the searching of the conventional database. The processes that are executed by the agents 31 with respect to the user's request for information collection are considered as having two methods of their being executed such as those illustrated in FIGS. 3 and 4.

The agent 31 analyzes which information collection method matches with the user's desire target. It is now assumed, for example, that the user has transmitted the message “The proposed brands of the cosmetics that will be put on sale with spring campaign. The cosmetics sounds soft and has an image of flowers for women in their twenties.” In this case, the contents of the message and the aim to collect information are fairly definite. In addition, what information sources access should be had to can be also relatively limited to a narrower range of information sources. On this account, it is now assumed that the agent 31 responds to the user's request with information source to another. This response example will now be explained with reference to FIG. 3. Determining the destination for information collection, the agent 3 first moves to the Web search engine of the data center 13, and collects information about the recent young women's trend toward cosmetics by using a keyword. The agent 31, while having that information with it, accesses the next database A (for example a database regarding flowers) and picks up the names of the spring flowers. The agent 31 adds that information further to its knowledge and then accesses the next database B (for example linguistics or acoustics) to thereby analyze the “sounding soft”. Further, the agent 31 accesses the database C (database on the trademarks). It thereby extracts the brand names, that are already registered, or the naming similar thereto, from among the information that it collected so far. For example, if the databases A, B, and C are legacy systems, the agent 31 utilizes those data via the legacy center 15. In this way, the agent 31 moves about one information source that it has determined as its target to another that it has so determined by the point in time when it comes back to the exchange center 16. Thereby, the agent 31 analyzes the information it has collected, and limits the proposed brand names to a narrower range of ones. Then, the agent 31 transmits the report destined for the user from the exchange center 16 to him or her via the communication center 11. Of course, after having transmitted the message requesting the information collection to the communication center 11, the user finishes his transmission. On the other hand, thereafter, the agent 31 collects the information. Therefore, the user later accesses the communication center 11 again and goes seeing the results. The transactions that are executed during that series of information collection processes are transmitted to the transaction monitoring center 12, in which the money-charging processing is executed.

Next, regarding the example wherein the user's request for information collection is over a wider range and therefore the information sources as the targets have the difficulty of being limited, the method illustrated in FIG. 4 is considered as being available. That example is, for example, the one wherein the user's message “The trend of consumption in the last half year” has been given. When the user's message is transmitted to the exchange center 16 via the communication center 11, the agent 31a playing the role that works as the manager receives the message and analyzes it. As a result of this, the processes for executing the user's request are divided and distributed to a plurality of agents 31b to 31e, which are dispatched to their respective information sources. Some agent is demanded, regarding the divided theme therefor, to collect information from the legacy system 25 and some agent is demanded to collect information from several Web sites. When coming back to the exchange center 16 after having collected their relevant information, the agents 31b to 31e write the results, for example, into a common memory area of the exchange center 16. When all the dispatched agents 31b to 31e write the results into the common memory area, the agent 31a that serves as the manager analyzes the collected results and, while newly comparing them with the user's message, arranges and summarizes them into a report. Then, the agent 31a transmits them to the user. The money-charging process, etc. are executed in the same way as was explained using FIG. 3.

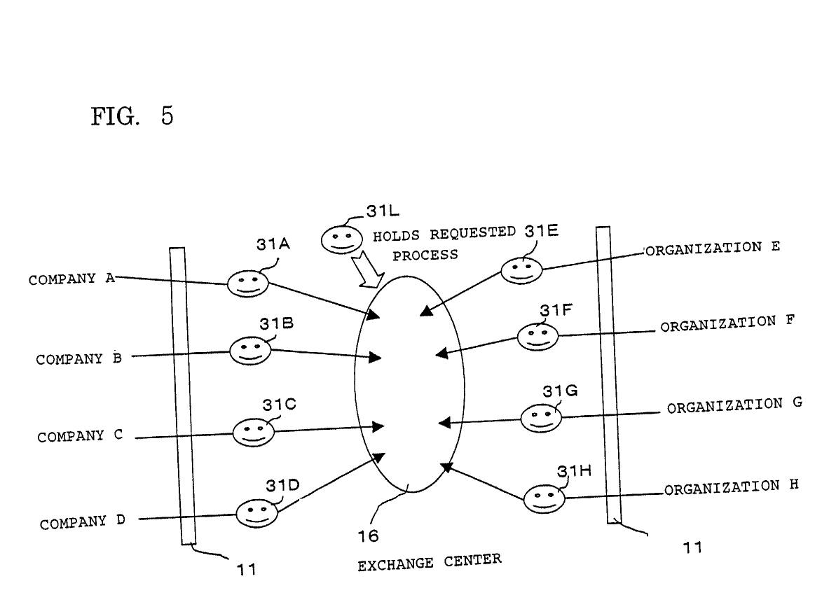

Next, with reference to FIG. 5, a case where bidding for public construction work has been performed utilizing the present net market system l will be explained. FIG. 5 is a view typically illustrating the relationship between bidding candidates, companies A to D, which want to receive an order for the public construction work by utilizing the present net market system 1 and organizations E to H that publicly invites persons who receive their orders in order for them to order their public construction works. The companies A to D transmit their own wanted items/conditions as bidding desire messages via the communication centers 11 of the present net market system 1. In order that the agents 31A to 31D may receive respective messages of the companies A to D and that the companies A to D may make their bidding for the public construction works matching with their wanted items/conditions, the agents 31A to 31D are allotted and mediate. On the other hand, the organizations E to H transmit the specification, conditions, etc. on their public construction works that are necessary for making their orders as their messages, via the communication center 11 of the present net market system 1. The agents 31A to 31D receive respective messages of those organizations E to H and write, for example, the specifications, conditions, bidding deadlines, etc. into the common memory of the exchange center 16. This common memory is provided, for example, on the exchange center 16 (see FIG. 1) and is supervised by the agent 31L which holds these pieces of bidding. The agent 31L sequentially compares the public construction works desired proposed items, that have been written into the common memory, with the users' request and makes its studies of them. It then picks up the bidding candidates to instruct them to the agents 31A to 31D in order for these agents to report to the users. Upon receipt of decisions to bid from the users, the agents 31A to 31D write into the common memory the presentation of the bidding conditions. On the other hand, the agent 31L, after the bidding deadline, performs comparison and study of the bidders' conditions, etc. Thereafter, it instructs the agents 31E to 31H to inform the most appropriate bidders to the organizations E to H that are the askers.

In this way, since if utilizing the present net market system the grouped agents mediate message processing, it is possible to easily perform matching of the requested items of many applicants with those of many public inviters. Namely, the applicants and public inviters can both choose their most appropriate partners from among a lot of proposed choices available. The process in the present net market system 1 is not limited to the case of bidding. It can be also applied, as in the case of auction, preparation of articles, or reservation of passports or accommodations, to matching of the buying conditions of many buyers with the selling conditions of many sellers, partner invitation for joint businesses, etc. Even nowadays, regarding specific market transactions that concern auctions, preparation of articles, reservation, etc., relevant services have been being provided at Web sites on the Internet. However, the system capable of performing synthetic, more flexible and optimum solution to the problems with regard to those services as in the case of the net market system according to the present invention has not yet been provided.

Incidentally, the present invention does not always need to take the procedure of the agent comparing the conditions asynchronously written into the common memory as in the example above. It can also take the procedure wherein the agents for buyers and the agents for sellers directly negotiate (or negotiate via an intermediate agent) and if the both conditions the negotiation becomes successfully concluded.

Also, if additionally using within the net market system an intermediate agent having the entrusting and investigating abilities and an intermediate agent mediating the bank settlement business, every piece of processing from the start to negotiate or bid up to the successful conclusion of negotiation/order-acceptance and the completion of the settlement can be completed within the net market system.

In the present net market system, by using as the mediation agents the agents equipped with the knowledge on various types of business models, it is possible to execute every piece of processing the users request to execute. The above-described examples of using the net market system are only illustrative, and the embodiment of the present invention is not limited to those examples. It is to be noted that, regarding the security, as well, that is greatly problematic in the today's transaction process executed via the Internet, the net market system of the present invention can solve the problems by interposing the agents having the function of guaranteeing the maintenance of the security. Optionally, a security center may be provided as the center function.

What is claimed is:

1. A net market system functioning as a portal for buying/selling and exchanging goods, information, and services via a network, comprising:
net market system connection/management means that functions as an interface for communications that are made with users via communication appliances including mobile phones, facsimiles, personal computers, and personal digital assistants;
transactions monitoring means that monitors transactions within the net market system that follow execution of processing based on messages sent from the users;
data storing/providing means that has been connected to the Internet and that stores data necessary for the execution of processing based on messages from the users or that provides data according to requests made by the users' messages;
application software providing means that provides application software that is necessary for execution of processing based on requests made by the users' messages;
legacy-system interface providing means that provides an interface for having access to, or utilizing, legacy systems or software; and
process-execution integrating/controlling means that integrates and controls execution of processing within the net market system based on the messages from the users.

2. The net market system according to claim 1, wherein the execution of processing based on the messages from the users is done through the agents.

3. The net market system according to claim 1, wherein the processing that are executed by the net market system connection/management means, transaction monitoring means, data storing/providing means, application software providing means, legacy-system interface providing means, and process-execution integrating/controlling means included in the net market system are executed through co-operation of necessary application software for execution of the respective processing or information processing system and agents.

4. The net market system according to claim 1, wherein the net market system connection/management means, transaction monitoring means, data storing/providing means, application software providing means, legacy-system interface providing means, and process-execution integrating/controlling means included in the net market system are executed through the co-operation of four Web servers:
an agent server that executes the management/integration of agents including creation, dispatch, extinction, and re-use of the agents;
a for-traffic-control high-speed cache server that is connected to the Internet and that executes controls of that includes the controls of cache function, data storage, and URL transfer destination of data that is used and transferred within the net market system;
a data server that functions as a database that stores therein and providing data that is used for the execution of processing that are executed within the net market system; and
an application server that provides application software that is used for the execution of processing within the net market system.

5. The net market system according to claim 1, wherein the transaction monitoring means executes a money-charging piece of processing regarding the use of the net market system that is executed with respect to the user.

6. The net market system according to claim 3, wherein the application software server provides, with respect to the user, in the way of allowing the user to use the function of application software via the network, the application software that has been accumulated on the server.

7. The net market system according to claim 3, wherein the agent server comprises an agent messaging server that has a function of helping the message communications between the agents that are executed between the agents and other agents within the net market system and between the agents and other agents within other net market, an agent name server that manages definitions and states of the agents that are used within the net market system, an agent monitoring server that records therein transactions between the agents and thereby manages basic data for being used to offer fundamental services including money-charging information and security management, an agent knowledge server that manages the agent knowledge that the respective agents can use, and an agent event server that manages and operates events that occur between the agents and the system the agents have relevancy to.
